(19) United States
(12) Patent Application Publication
(10) Pub. No.: US 2023/0119396 A1
(43) Pub. Date: Apr. 20, 2023

(54) SMART PRODUCT SALES AND MANUFACTURING

(71) Applicant: Dell Products L.P., Round Rock, TX (US)

(72) Inventors: Bijan Kumar Mohanty, Austin, TX (US); Satyam Sheshansh, Bangalore (IN); Hung Dinh, Austin, TX (US); Durga Ram Singh Bondili, Chennai (IN)

(73) Assignee: Dell Products L.P., Round Rock, TX (US)

(21) Appl. No.: 17/505,399

(22) Filed: Oct. 19, 2021

(51) Int. Cl. G06Q 30/06; G06N 3/08

(52) U.S. Cl. CPC G06Q 30/0621; G06N 3/08; G06Q 30/0633

(57) ABSTRACT

An example methodology implementing the disclosed techniques includes receiving a parts configuration specified for a product and generating a first feature vector that represents features from the product. The method also includes predicting, using a trained quote-time issue prediction module, whether the parts configuration specified for the product will or will not result in issues based on the first feature vector and, responsive to a prediction that the parts configuration specified for the product will not result in issues, accepting an order for the product. The method may further include receiving manufacturing details selected for the product, generating a second feature vector that represents features from the product and the selected manufacturing details, and predicting, using a trained manufacture-time issue prediction module, whether producing the product in accordance with the selected manufacturing details will or will not result in issues based on the second feature vector.

### BACKGROUND

Product quality can significantly affect product sales, return, support, and customer experience. For instance, poor quality products can result in customer dissatisfaction and, in some cases, loss of customer loyalty. Poor quality products can also lead to increased product returns and support issues, which can negatively impact enterprises who manufacture and/or sell such products. For example, increased defects in product parts and manufacturing can result in higher manufacturing and service costs, which negatively impact the enterprises' purchasing decisions and profitability.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a computer implemented method to predict whether a parts configuration specified for a product will result in issues includes, by an order management system, receiving a parts configuration specified for a product and generating a first feature vector that represents one or more features from the product. The method also includes predicting, by a trained quote-time issue prediction module, whether the parts configuration specified for the product will or will not result in issues based on the first feature vector. The method further includes, responsive to a prediction that the parts configuration specified for the product will not result in issues, accepting an order for the product.

In some embodiments, the trained quote-time issue prediction module is trained using a training dataset generated from a corpus of historical product data.

In some embodiments, the method also includes, responsive to a prediction that the parts configuration specified for the product will result in issues, denying an order for the product.

In some embodiments, the trained quote-time issue prediction module includes a dense neural network (DNN). In one aspect, the DNN of the trained quote-time issue prediction module functions as a binary classifier.

In some embodiments, the method also includes, by the order management system, receiving manufacturing details selected for the product and generating a second feature vector that represents one or more features from the product and the manufacturing details selected for the product. The method further includes predicting, by a trained manufacture-time issue prediction module, whether producing the product in accordance with the selected manufacturing details will or will not result in issues based on the second feature vector.

In some embodiments, the trained manufacture-time issue prediction module is trained using a training dataset generated from a corpus of historical product and manufacturing data.

In some embodiments, the trained manufacture-time issue prediction module includes a dense neural network (DNN). In one aspect, the DNN of the trained manufacture-time issue prediction module functions as a binary classifier.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to receive a parts configuration specified for a product and generate a first feature vector that represents one or more features from the product. Execution of the instructions also causes the one or more processors to predict, using a trained quote-time issue prediction module, whether the parts configuration specified for the product will or will not result in issues based on the first feature vector. Execution of the instructions further causes the one or more processors to, responsive to a prediction that the parts configuration specified for the product will not result in issues, accept an order for the product.

In some embodiments, the trained quote-time issue prediction module is trained using a training dataset generated from a corpus of historical product data.

In some embodiments, execution of the instructions also causes the one or more processors to, responsive to a prediction that the parts configuration specified for the product will result in issues, deny an order for the product.

In some embodiments, the trained quote-time issue prediction module includes a dense neural network (DNN). In one aspect, the DNN of the trained quote-time issue prediction module functions as a binary classifier.

In some embodiments, execution of the instructions also causes the one or more processors to receive manufacturing details selected for the product, generate a second feature vector that represents one or more features from the product and the manufacturing details selected for the product, and predict, using a trained manufacture-time issue prediction module, whether producing the product in accordance with the selected manufacturing details will or will not result in issues based on the second feature vector.

In some embodiments, the trained manufacture-time issue prediction module is trained using a training dataset generated from a corpus of historical product and manufacturing data.

In some embodiments, the trained manufacture-time issue prediction module includes a dense neural network (DNN). In one aspect, the DNN of the trained manufacture-time issue prediction module functions as a binary classifier.

According to another illustrative embodiment provided to illustrate the broader concepts described herein, a non-transitory, computer-readable storage medium has encoded thereon instructions that, when executed by one or more processors, causes a process to be carried out. The process includes receiving a parts configuration specified for a product that is being ordered and generating a first feature vector that represents one or more features from the product. The process also includes predicting, using a trained quote-time issue prediction module, whether the parts configuration specified for the product will or will not result in issues based on the first feature vector, wherein the trained quote-time issue prediction module is trained using a training dataset generated from a corpus of historical product data. The process further includes, responsive to a prediction that the parts configuration specified for the product will not result in issues, accepting an order for the product.

In some embodiments, the process also includes, responsive to a prediction that the parts configuration specified for the product will result in issues, denying an order for the product.

In some embodiments, the process also includes receiving manufacturing details selected for the product and generating a second feature vector that represents one or more features from the product and the manufacturing details selected for the product. The process further includes predicting, using a trained manufacture-time issue prediction module, whether producing the product in accordance with the selected manufacturing details will or will not result in issues based on the second feature vector, wherein the trained manufacture-time issue prediction module is trained using a training dataset generated from a corpus of historical product and manufacturing data.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative architecture of a product issue determination system, in accordance with an embodiment of the present disclosure.

FIG. 2 is a diagram showing an illustrative data structure that represents a training dataset for training a learning model to predict whether a parts configuration specified for a product will result in issues, in accordance with an embodiment of the present disclosure.

FIG. 3 is a diagram showing an illustrative data structure 300 that represents a training dataset for training a learning model to predict whether a product having a specified parts configuration produced in accordance with a selected manufacturing details will result in issues, in accordance with an embodiment of the present disclosure.

FIG. 4 is a diagram illustrating an example architecture of a dense neural network (DNN) model of a quote-time issue prediction module, in accordance with an embodiment of the present disclosure.

FIG. 5 is a diagram showing an example quote-time issue prediction topology that can be used to predict whether a parts configuration specified for a product will result in issues, in accordance with an embodiment of the present disclosure.

FIG. 6 is a diagram illustrating an example architecture of a dense neural network (DNN) model of a manufacture-time issue prediction module, in accordance with an embodiment of the present disclosure.

FIG. 7 is a diagram showing an example manufacture-time issue prediction topology that can be used to predict whether a product having a specified parts configuration produced in accordance with a selected manufacturing details will result in issues, in accordance with an embodiment of the present disclosure.

FIG. 8 is a flow diagram of an example process for predicting product issues, in accordance with an embodiment of the present disclosure.

FIG. 9 is a block diagram illustrating selective components of an example computing device in which various aspects of the disclosure may be implemented, in accordance with an embodiment of the present disclosure.

### DETAILED DESCRIPTION

Product returns and excessive product support issues can result in significant cost liabilities for manufacturers. For example, a substantial number of returns of sold and/or ordered products can cut deeply into the profit margins of an enterprise since these product returns may require reverse logistics, re-testing, restocking, and reduced pricing in reselling the products as refurbished items. In addition, product returns and support issues as a result of defects in a product (e.g., defective product) can negatively impact the brand value of the product and significantly affect revenue. As a result, enterprises are in the continuous pursuit of minimizing product returns and defects.

It is appreciated herein that a potential application of machine learning (ML) is for the timely identification of potential issues (problems) with products and/or manufacturing of products as various points in the supply chain. For example, an enterprise may provide its customers an option at the time of quoting to select and configure different parts in a complex product such as like server systems and storage systems. Predicting potential product returns and increased product support issues due to the various configuration of parts may allow for optimizing the configuration of products during the product sales quoting process. Similarly, at the manufacturing/assembly phase, the enterprise may have options to select factories, shop floors, and logistics providers, etc., to balance product orders and optimize logistics, for example. Predicting possible issues/problems with the selected shop floors, factories and/or partners may allow for optimizing selection of suppliers, manufacturing/assembly facilities, and partners during the manufacturing phase. Prediction of such issues/problems allows for producing quality products, thus reducing (and ideally minimizing) product returns and defects and improving customer satisfaction.

To this end, certain embodiments of the concepts, techniques, and structures disclosed herein are directed to predicting whether a specific parts configuration for a product will result in product issues based on historical product data. In some embodiments, a learning model (e.g., a classification learning model) may be trained using machine learning techniques (including neural networks) to predict whether a specific parts configuration specified for a product will or will not result in issues. For example, to train the model, historical product data (e.g., historical product order fulfillment, return, and defect data such as information regarding past products ordered and sold, past product returns, and past product defects) can be collected. Once this data is collected, the variables or parameters (also called features) that are correlated to or influence (or contribute to) the prediction of whether a parts configuration specified for a product will result in issues, or will not result in issues, can be determined (e.g., identified) from the corpus of historical product data. These relevant features can then be used to generate a dataset (e.g., a training dataset) that can be used to train the model. A feature (also known as an independent variable in machine learning) is an attribute that is useful or meaningful to the problem that is being modeled (e.g., predicting whether a parts configuration specified for a product will or will not result in issues). Once trained using the training dataset, the trained model can be used to predict, provided information (e.g., features) regarding a parts configuration specified for a product, whether the specified parts configuration for the product will result in issues. In some such embodiments, the prediction of potential issues for a parts configuration specified for a product may be made when the product is being ordered and/or when quoting the product for sale (also referred to herein as quote time). Being able to accurately predict whether a parts configuration specified for a product will or will not result in issues allows enterprises to optimize a configuration for the product at product quote time. This prediction also allows the enterprise to offer quality products to its customers as well as reduce (and ideally eliminate) the risks associated with producing and selling products which may have issues and/or problems.

According to some embodiments disclosed herein, a prediction of whether a specific parts configuration for a product will result in issues can be made at or prior to the time of producing the product (also referred to herein as manufacture time). For example, additional manufacturing details such as manufacturing/assembly facilities, locations of shop floors, and logistics providers, among others, selected to produce the product which were not known at product quote time may now be known. Such additional manufacturing data can also be used with the historical product data as indicators for predicting whether a product having a specified parts configuration that is produced based on the manufacturing data will result in product issues.

To this end, in some embodiments, a learning model (e.g., a classification learning model) may be trained using machine learning techniques (including neural networks) to predict whether a product having a specified parts configuration that is produced using the selected manufacturing/assembly facility, shop floor(s), and logistics provider(s) will or will not result in issues. For example, to train the model, historical product order fulfillment, return, defect, and manufacturing data (e.g., information regarding past products ordered and sold, past product returns, past product defects, past product manufacturing details) can be collected. Once this data is collected, the features that are correlated to or influence (or contribute to) the prediction of whether a product having a specified parts configuration that is produced in accordance with a selected manufacturing details (e.g., selected manufacturing/assembly facility, shop floor(s), and/or logistics provider(s)) will result in issues, or will not result in issues, can be determined (e.g., identified) from the corpus of historical product and manufacturing data. These relevant features can then be used to generate a training dataset that can be used to train the model. Once trained using the training dataset, the trained model can be used to predict, provided information (e.g., features) regarding a product, its parts configuration, and manufacturing details (e.g., manufacturing/assembly facility, shop floor(s), and/or logistics provider(s)) selected to produce the product, whether the product produced in accordance with the selected manufacturing details will result in issues. In some such embodiments, the prediction of potential issues for a parts configuration specified for a product may be made prior to actually producing the product. Being able to accurately predict whether a product having a specified parts configuration with the selected manufacturing details will or will not result in issues allows an enterprise to predict potential issues and problems with the selected factories, shop floors, and partners, among others. This prediction also allows the enterprise to reduce (and ideally eliminate) the probability of producing products which may have issues and/or problems.

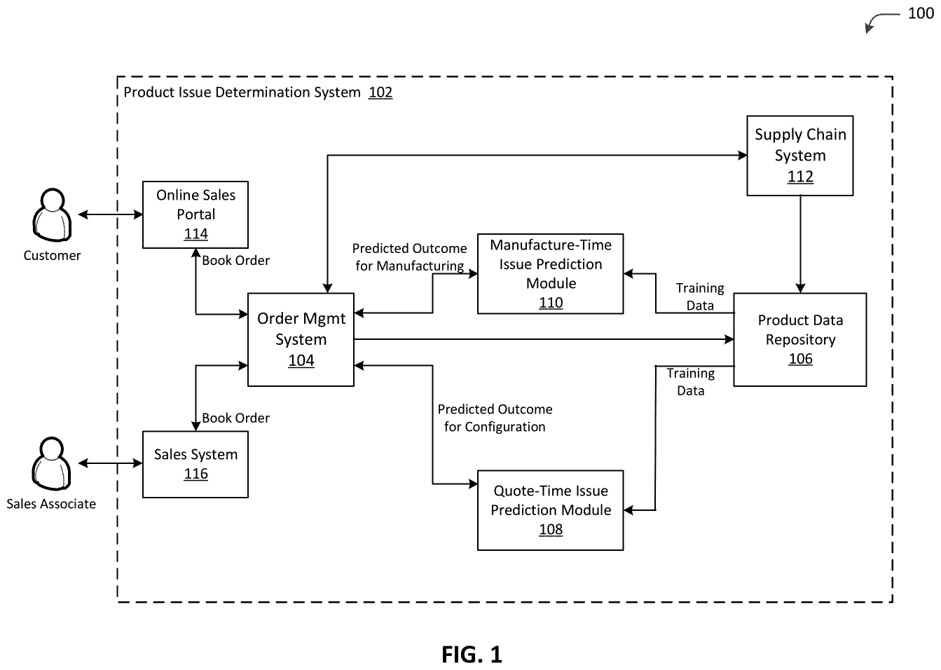

Referring now to the figures, FIG. 1 is a diagram of an illustrative architecture 100 of a product issue determination system 102, in accordance with an embodiment of the present disclosure. An enterprise, for instance, may implement and use product issue determination system 102 to determine whether a product having a specified parts configuration, if produced, will result in potential issues (e.g., defects, returns, etc.). In some embodiments, product issue determination system 102 can be used to make this determination at product quote time and/or at product manufacture time. As shown, product issue determination system 102 includes an order management system 104, a product data repository 106, a quote-time issue prediction module 108, a manufacture-time issue prediction module 110, a supply chain system 112, an online sales portal 114, and a sales system 116. Product issue determination system 102 can include various other hardware and software components which, for the sake of clarity, are not shown in FIG. 1. It is also appreciated that product issue determination system 102 may not include certain of the components depicted in FIG. 1. For example, in certain embodiments, product issue determination system 102 may not include supply chain system 112. As another example, in some embodiments, product issue determination system 102 may not include online sales portal 114 and/or sales system 116. In some such embodiments, some or all of the functionality provided by the excluded components may be provided by one or more of the included components of product issue determination system 102 or provided by one or more systems that are external to product issue determination system 102. Thus, it should be appreciated that numerous configurations of product issue determination system 102 can be implemented and the present disclosure is not intended to be limited to any particular one.

The various components of architecture 100, including the components of product issue determination system 102, may be communicably coupled to one another via one or more networks (not shown). The network may correspond to one or more wired or wireless computer networks including, but not limited to, local area networks (LANs), wide area networks (WANs), personal area networks (PANs), metropolitan area networks (MANs), storage area networks (SANs), virtual private networks (VPNs), wireless local-area networks (WLAN), primary public networks, primary private networks, Wi-Fi (i.e., 802.11) networks, other types of networks, or some combination of the above.

Order management system 104 provides management of the enterprise's processes (e.g., back-end processes) for managing and fulfilling product orders. Order management system 104 can provide tracking of sales, orders, inventory, and fulfillment as well as facilitating automation between the enterprise's various service providers. Order management system 104 enables the enterprise to manage orders coming in (e.g., booking of product orders) from multiple sales channels and going out of multiple fulfillment points. Order management system 104 can store or otherwise maintain its data (e.g., data regarding or otherwise associated with product sales, orders, inventory, fulfillment, returns, and support) in a database or other persistent storage, such as, for example, product data repository 106.

At various stages in the different processes, order management system 104 may determine whether a product having a specified parts configuration, if produced, will result in potential issues. For example, when a parts configuration has been specified for a product, during the product quoting process for instance, order management system 104 may receive a request to determine whether the specified parts configuration for the product will result in issues. In response to receiving the request, order management system 104 may determine whether the specified parts configuration for the product will result in issues. To do so, in some embodiments, order management system 104 can leverage quote-time issue prediction module 108 to predict whether a parts configuration specified for a product will or will not result in issues. As another example, when the manufacturing details are selected to produce a product (e.g., to produce an ordered product), order management system 104 may determine whether producing the product in accordance with the selected manufacturing details will result in issues. To do so, in some embodiments, order management system 104 can leverage manufacture-time issue prediction module 110 to predict whether producing a product having a specified parts configuration in accordance with a selected manufacturing details, such as manufacturing/assembly facility, shop floor(s), and logistics provider(s), will result in issues. Quote-time issue prediction module 108 and manufacture-time issue prediction module 110 will be further described below.

Still referring to FIG. 1, supply chain system 112 provides management of the enterprise's supply chain processes, including planning, sourcing, producing, delivering, and providing for returns. Supply chain system 112 can provide efficient handling of the flow of goods from the enterprise's suppliers to the enterprise's customers. Supply chain system 112 can store or otherwise maintain the data provided by suppliers and logistic providers in a database or other persistent storage, such as, for example, product data repository 106. Supply chain system 112 may also provide some or all of the data to order management system 104.

Online sales portal 114 provides the enterprise's online interface and tools for facilitating online sales of the enterprise's products. For example, a customer or a potential customer may use a user interface of online sales portal 114 and specify a parts configuration for a product. The customer can then use online sales portal 114 and place or otherwise submit an order for the product with the specified parts configuration. Prior to or at the time of placing the order, the customer may inquire as to whether the specified parts configuration for the product will result in issues. In response to the inquiry, online sales portal 114 can send a request to determine whether the specified parts configuration for the product will result in issues to order management system 104. Upon receiving a response to the request (e.g., the specified parts configuration for the product will result in issues or the specified parts configuration for the product will not result in issues), online sales portal 114 can present the response to the customer, for example. The customer can then take appropriate action based on the response. For example, if the specified parts configuration for the product will result in issues, the customer may change the parts configuration for the product. Note that the customer may inquire about potential issues with a specific parts configuration for a product without placing an order for the product. For example, the customer may want to know whether a specific parts configuration for a product will result in issues before placing an order for the product.

Sales system 116 provides management of the enterprise's various processes for managing sales opportunities. For example, employees (e.g., sales associates) and others associated with the enterprise's sales team may use the various processes of sales system 116 to track data, perform administrative tasks, and manage sales leads, among others. In one embodiment, sales system 116 can be used to send a request to determine whether a specified parts configuration for a product will result in issues to order management system 104. For example, when a product having a specified parts configuration is being quoted to a customer, a sales team member can use sales system 116 to send a request to determine whether the specified parts configuration for the product will result in issues. As another example, when a sales team member enters an order for a product having a specified parts configuration into sales system 116, sales system 116 can send a request to determine whether the specified parts configuration for the product will result in issues. In any case, sales system 116 can receive a response to the issued request (e.g., the specified parts configuration for the product will result in issues or the specified parts configuration for the product will not result in issues) and present the response to the sales team member, for example. The sales team member can then take appropriate action based on the response. For example, if the specified parts configuration for the product will result in issues, the sales team member may advise the customer of the potential for issues and discuss alternate parts configuration(s) with the customer.

With continued reference to FIG. 1, product data repository 106 stores or otherwise records historical product data. The historical product data may include information regarding the products sold by the enterprise such as product order fulfillment, return, and defect data (e.g., information regarding past products ordered and sold, past product returns, and past product defects). For example, as can be seen in FIG. 1, the historical product sales/orders and order fulfillment data may be collected or otherwise obtained from the enterprise's order management system 104. Historical product returns, support, and defect data may be collected from the enterprise's reverse logistics systems (not shown). Thus, in such embodiments, product data repository 106 can be understood as a storage point for data that is collected from the enterprise's various systems (e.g., order management system 104 and reverse logistics systems) and which is used to generate a training dataset that can be used to train a model (e.g., quote-time issue prediction module 108) to predict, at quote time, whether a specified parts configuration for a product will result in issues.

In some embodiments, the historical product data may be stored in a tabular format. In the table, the structured columns represent the features (also called variables) and each row represents an observation or instance (e.g., whether a past product having a specific parts configuration did or did not have issues). Thus, each column in the table shows a different feature of the instance. In some embodiments, product data repository 106 can perform preliminary operations with the collected historical product data (e.g., information regarding the past products sold by the enterprise) to generate the training dataset. For example, the preliminary operations may include null data handling (e.g., the handling of missing values in the table). According to one embodiment, null or missing values in a column (a feature) may be replaced by a mode or median value of the values in that column. According to alternative embodiments, observations in the table with null or missing values in a column may be removed from the table.

The preliminary operations may also include feature selection and/or data engineering to determine (e.g., identify) the relevant features from the historical product data. The relevant features are the features that are more correlated with the thing being predicted by the trained model (e.g., whether a specified parts configuration for a product will result in issues). A variety of feature engineering techniques, such as exploratory data analysis (EDA) and/or bivariate data analysis with multivariate-variate plots and/or correlation heatmaps and diagrams, among others, may be used to determine the relevant features. Such feature engineering may be performed to reduce the dimension and complexity of the trained model, hence improving its accuracy and performance.

The preliminary operations may also include data preprocessing to place the data (information) in the table into a format that is suitable for training a model. For example, since machine learning deals with numerical values, textual categorical values (i.e., free text) in the columns (e.g., customer, product, configuration part, supplier, etc.) can be converted (i.e., encoded) into numerical values. According to one embodiment, the textual categorical values may be encoded using label encoding. According to alternative embodiments, the textual categorical values may be encoded using one-hot encoding.

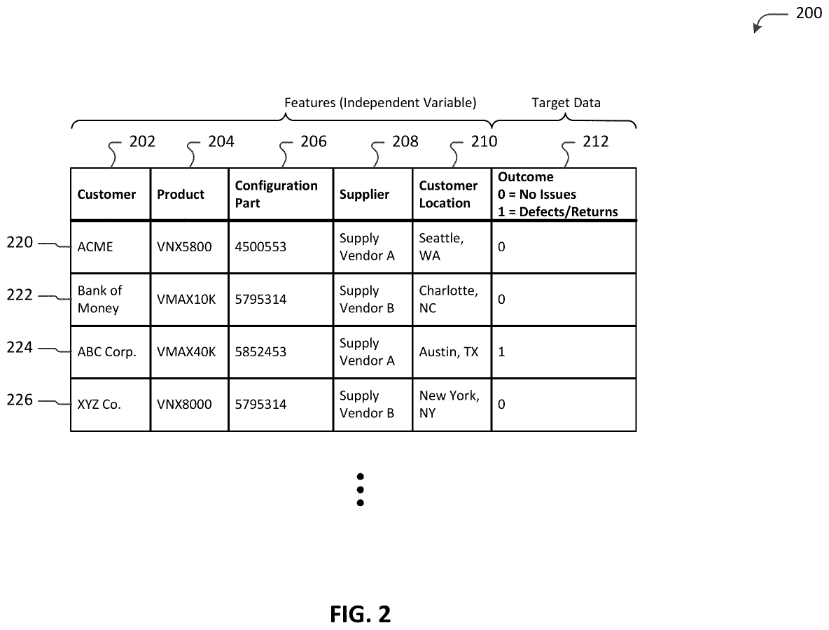

FIG. 2 is a diagram showing an illustrative data structure 200 that represents a training dataset for training a learning model to predict whether a parts configuration specified for a product will result in issues, in accordance with an embodiment of the present disclosure. More specifically, data structure 200 may be in a tabular format in which the structured columns represent the different relevant features (variables) regarding the past products sold by the enterprise and a row represents individual products sold. The relevant features illustrated in data structure 200 are merely examples of features that may be extracted from the historical product data and used to generate a training dataset and should not be construed to limit the embodiments described herein.

As shown in FIG. 2, the relevant features may include a customer 202, a product 204, a configuration part 206, a supplier 208, a customer location 210, and an outcome 212. Customer 202 indicates a customer who purchased the product (i.e., customer who purchased the past product sold by the enterprise). Product 204 indicates a product number that identifies the product. Configuration part 206 indicates a part number that identifies a part (component) that is included in the product. For example, the indicated part is one of the parts that was used in configuring the product. Supplier 208 indicates a supplier who supplied or otherwise provided the part (e.g., the part indicated in configuration parts 206). Customer location 210 indicates a location at which the customer received the product. Outcome 212 indicates whether there were no or minimal issues with the product (e.g., “0=No Issues”) or whether there were more than minimal issues with the product, such as a product defect and/or a product return (e.g., “1=Defects/Returns”). Note that only one part (e.g., configuration part 206) and one supplier of the part (e.g., supplier 208) are shown as relevant features in FIG. 2 for purposes of clarity, and it will be appreciated that the relevant features can include more than one part and more than one supplier as a product will typically be configured with more than one part that has influence on the performance of the model (i.e., that are relevant (or influential) in predicting whether a specified parts configuration for a product will result in issues).

In data structure 200, each row may represent a training sample (i.e., an instance of a training sample) in the training dataset, and each column may show a different relevant feature of the training sample. Each training sample may correspond to a past product that was sold by the enterprise. As can be seen in FIG. 2, four training samples 220, 222, 224, 226 are illustrated in data structure 200. In some embodiments, the individual training samples 220, 222, 224, 226 may be used to generate a feature vector, which is a multi-dimensional vector of elements or components that represent the features in a training sample. In such embodiments, the generated feature vectors may be used for training a model to predict whether a specified parts configuration for a product will result in issues. The features customer 202, product 204, configuration part 206, supplier 208, and customer location 210 may be included in a training sample as the independent variables, and the feature outcome 212 included as the dependent (or target) variable in the training sample. Note that the number of training samples depicted in data structure 200 is for illustration, and those skilled in the at will appreciate that the training dataset may, and likely will, include large and sometimes very large numbers of training samples.

Referring again to FIG. 1, in some embodiments, product data repository 106 may also store or otherwise record manufacturing data related to the historical product data (e.g., historical products sold by the enterprise). The manufacturing data may include information related to producing and supplying (e.g., manufacturing/assembling) the past products. For example, as can be seen in FIG. 1, the manufacturing data may be collected or otherwise obtained from the enterprise's supply chain systems 112. Thus, in such embodiments, product data repository 106 can be understood as a storage point for data that is collected from the enterprise's various systems (e.g., order management system 104, supply chain systems 112, and reverse logistics systems) and which is used to generate a training dataset that can be used to train a model (e.g., manufacture-time issue prediction module 110) to predict, at manufacture time, whether producing a product having a specified parts configuration based on the manufacturing data for the product will result in issues.

In some embodiments, the historical product and manufacturing data may be stored in a tabular format. In the table, the structured columns represent the features (also called variables) and each row represents an observation or instance (e.g., whether producing a past product having a specific parts configuration with the indicated manufacturing details did or did or did not result issues). Thus, each column in the table shows a different feature of the instance. In some embodiments, product data repository 106 can perform preliminary operations with the collected historical product and manufacturing data (i.e., information regarding the past products produced and/or sold by the enterprise) to generate the training dataset. For example, similar to the preliminary operations with the historical product data described above, the preliminary operations may include null data handling of missing values in the table, feature selection and/or data engineering to determine (e.g., identify) the relevant features from the historical product and manufacturing data, and/or data preprocessing to place the data (information) in the table into a format that is suitable for training a model, as described above.

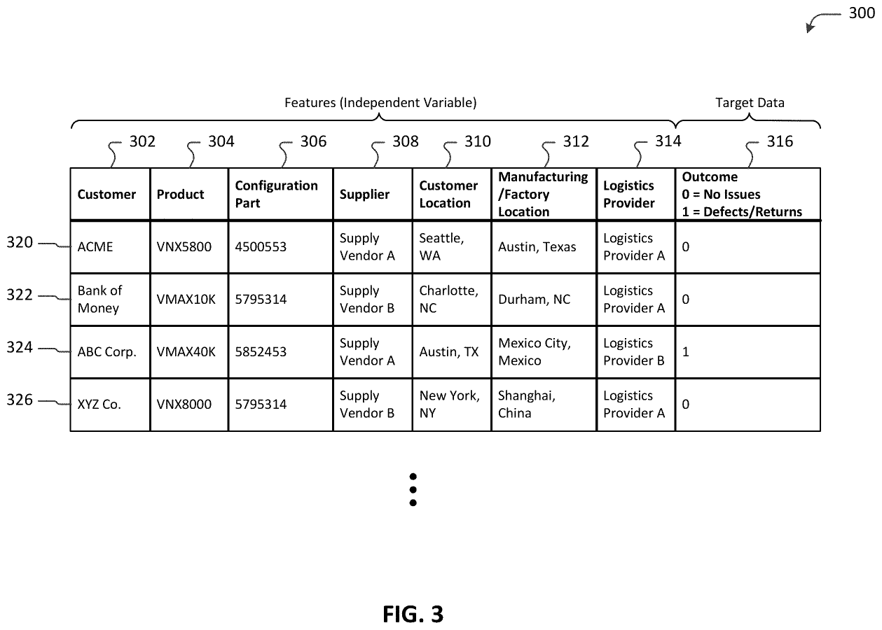

FIG. 3 is a diagram showing an illustrative data structure 300 that represents a training dataset for training a learning model to predict whether a product having a specified parts configuration produced in accordance with a selected manufacturing details will result in issues, in accordance with an embodiment of the present disclosure. Data structure 300 may be in a tabular format in which the structured columns represent the different relevant features (variables) regarding the past products sold by the enterprise and a row represents the individual products sold. The relevant features illustrated in data structure 300 are merely examples of features that may be extracted from the historical product and manufacturing data and used to generate a training dataset and should not be construed to limit the embodiments described herein.

As shown in FIG. 3, the relevant features may include a customer 302, a product 304, a configuration part 306, a supplier 308, a customer location 310, a manufacturing/factory location 312, a logistics provider 314, and an outcome 316. Customer 302, product 304, configuration part 306, supplier 308, and customer location 310 are substantially similar to customer 202, product 204, configuration part 206, supplier 208, and customer location 210, respectively, previously described with respect to data structure 200 of FIG. 2, and that relevant discussion is equally applicable here. Manufacturing/factory location 312 indicates a location at which the product was produced (e.g., manufactured and/or assembled). Logistics provider 314 indicates a company or entity that provided delivery of the product from the manufacturing/factory location to the customer location. Outcome 316 indicates whether there were no or minimal issues with the product produced in accordance with the indicated manufacturing details (e.g., “0=No Issues”) or whether there were more than minimal issues with the product produced in accordance with the indicated manufacturing details, such as a product defect and/or a product return (e.g., “1=Defects/Returns”).

Similar to data structure 200 described above, in data structure 300, each row may represent a training sample (i.e., an instance of a training sample) in the training dataset, and each column may show a different relevant feature of the training sample. Each training sample may correspond to a past product that was produced and sold by the enterprise. As can be seen in FIG. 3, four training samples 320, 322, 324, 326 are illustrated in data structure 300. In some embodiments, the individual training samples 320, 322, 324, 326 may be used to generate a feature vector, which is a multi-dimensional vector of elements or components that represent the features in a training sample. In such embodiments, the generated feature vectors may be used for training a model to predict whether a product having a specified parts configuration produced in accordance with a selected manufacturing details will result in issues. The features customer 302, product 304, configuration part 306, supplier 308, customer location 310, manufacturing/factory location 312, and logistics provider 314 may be included in a training sample as the independent variables, and the feature outcome 316 included as the dependent (or target) variable in the training sample. Note that the number of training samples depicted in data structure 300 is for illustration, and those skilled in the at will appreciate that the training dataset may, and likely will, include large and sometimes very large numbers of training samples.

Referring again to FIG. 1, quote-time issue prediction module 108 can predict whether a parts configuration specified for a product will or will not result in issues. To this end, in some embodiments, quote-time issue prediction module 108 includes a learning model (e.g., a dense neural network (DNN)) that is trained using machine learning techniques with a training dataset generated using historical product data. The DNN may be a binary classification model (e.g., a binary classifier). In such embodiments, the training dataset may be provided by product data repository 106. In some embodiments, a randomly selected portion of the training dataset can be used for training the DNN, and the remaining portion of the training dataset can be used as a testing dataset. In one embodiment, 70% of the training dataset can be used to train the model, and the remaining 30% can be used to form the testing dataset. The model can then be trained using the portion of the training dataset (i.e., 70% of the training dataset) designated for training the model. Once trained, the testing dataset can be applied to the trained model to evaluate the performance of the trained model.

In brief, the DNN includes an input layer for all input variables such as customer, product, configuration part(s), supplier(s), customer location, etc., multiple hidden layers for feature extraction, and an output layer. Each layer may be comprised of a number of nodes or units embodying an artificial neuron (or more simply a “neuron”). As a DNN, each neuron in a layer receives an input from all the neurons in the preceding layer. In other words, every neuron in each layer is connected to every neuron in the preceding layer and the succeeding layer. As a binary classification model, the output layer is comprised of a single neuron, which outputs a first numerical value (e.g., 1) that represents issues (i.e., a parts configuration specified for a product will result in issues) and a second numerical value (e.g., 0) that represents no issues (i.e., a parts configuration specified for a product will not result in issues).

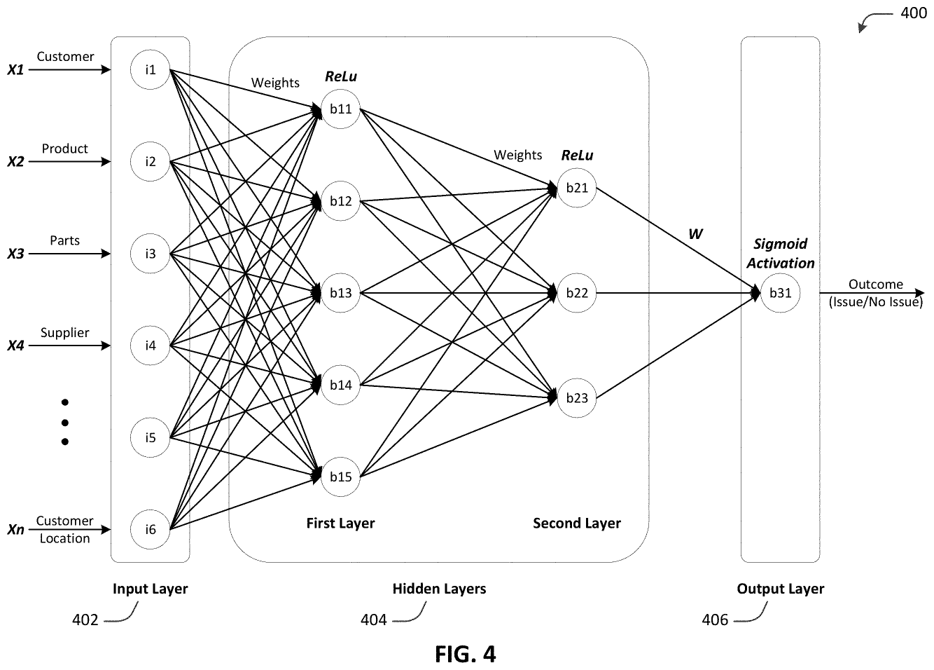

In more detail, and as shown in FIG. 4, a DNN 400 includes an input layer 402, multiple hidden layers 404 (e.g., two hidden layers), and an output layer 406. Input layer 402 may be comprised of a number of neurons to match (i.e., equal to) the number of input variables (independent variables). Taking as an example the independent variables illustrated in data structure 200 (FIG. 2), input layer 402 may include 5 neurons to match the 5 independent variables (e.g., customer 202, product 204, configuration part 206, supplier 208, and customer location 210), where each neuron in input layer 402 receives a respective independent variable. Each succeeding layer (e.g., a first layer and a second layer) in hidden layers 404 will further comprise an arbitrary number of neurons, which may depend on the number of neurons included in input layer 402. For example, according to one embodiment, the number of neurons in the first hidden layer may be determined using the relation 2n number of neurons in input layer, where n is the smallest integer value satisfying the relation. In other words, the number of neurons in the first layer of hidden layers 404 is the smallest power of 2 value equal to or greater than the number of neurons in input layer 402. For example, in the case where there are 19 input variables, input layer 402 will include 19 neurons. In this example case, the first layer can include 32 neurons (i.e., 2⁵=32). Each succeeding layer in hidden layers 404 may be determined by decrementing the exponent n by a value of one. For example, the second layer can include 16 neurons (i.e., 2⁴=16). In the case where there is another succeeding layer (e.g., a third layer) in hidden layers 404, the third layer can include 8 neurons (i.e., 2³=8). As a binary classification model, output layer 406 includes a single neuron.

Although FIG. 4 shows hidden layers 404 comprised of only two layers, it will be understood that hidden layers 404 may be comprised of a different number of hidden layers. Also, the number of neurons shown in the first layer and in the second layer of hidden layers 404 is for illustration only, and it will be understood that actual numbers of neurons in the first layer and in the second layer of hidden layers 404 may be based on the number of neurons in input layer 402.

Each neuron in hidden layers 404 and the neuron in output layer 406 may be associated with an activation function. For example, according to one embodiment, the activation function for the neurons in hidden layers 404 may be a rectified linear unit (ReLU) activation function. As DNN 400 is to function as a binary classification model, the activation function for the neuron in output layer 406 may be a sigmoid activation function.

Since this is a dense network, as can be seen in FIG. 4, each neuron in the different layers may be coupled to one another. Each coupling (i.e., each interconnection) between two neurons may be associated with a weight, which may be learned during a learning or training phase. Each neuron may also be associated with a bias factor, which may also be learned during a training process.

During a first pass (epoch) in the training phase, the weight and bias values may be set randomly by the neural network. For example, according to one embodiment, the weight and bias values may all be set to 1 (or 0). Each neuron may then perform a linear calculation by combining the multiplication of each input variables (x1, x2, . . . ) with their weight factors and then adding the bias of the neuron. The formula for this calculation may be as follows:

ws1=x1·w1+x2·w2+···+b1,

where ws1 is the weighted sum of the neuron1, x1, x2, etc. are the input values to the model, w1, w2, etc. are the weight values applied to the connections to the neuron1, and b1 is the bias value of neuron1. This weighted sum is input to an activation function (e.g., ReLU) to compute the value of the activation function. Similarly, the weighted sum and activation function values of all the other neurons in a layer are calculated. These values are then fed to the neurons of the succeeding (next) layer. The same process is repeated in the succeeding layer neurons until the values are fed to the neuron of output layer 406. Here, the weighted sum may also be calculated and compared to the actual target value. Based on the difference, a loss value is calculated. The loss value indicates the extent to which the model is trained (i.e., how well the model is trained). This pass through the neural network is a forward propagation, which calculates the error and drives a backpropagation through the network to minimize the loss or error at each neuron of the network. Considering the error/loss is generated by all the neurons in the network, backpropagation goes through each layer from back to forward and attempts to minimize the loss using, for example, a gradient descent-based optimization mechanism or some other optimization method. Since the neural network is used as a binary classifier, binary cross entropy may be used as the loss function, adaptive movement estimation (Adam) as the optimization algorithm, and “accuracy” as the validation metric. In other embodiments, unpublished optimization algorithm designed for neural networks (RMSprop) may be used as the optimization algorithm.

The result of this backpropagation is used to adjust (update) the weight and bias values at each connection and neuron level to reduce the error/loss. An epoch (one pass of the entire training dataset) is completed once all the observations of the training data are passed through the neural network. Another forward propagation (e.g., epoch 2) may then be initiated with the adjusted weight and bias values and the same process of forward and backpropagation may be repeated in the subsequent epochs. Note that a higher loss value means the model is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train the model. In any case, once the loss is reduced to a very small number (ideally close to zero (0)), the neural network is sufficiently trained for prediction.

DNN 400 can be built by first creating a shell model and then adding desired number of individual layers to the shell model. For each layer, the number of neurons to include in the layer can be specified along with the type of activation function to use and any kernel parameter settings. Once DNN 400 is built, a loss function (e.g., binary cross entropy), an optimizer algorithm (e.g., Adam or a gradient-based optimization technique such as RMSprop), and validation metrics (e.g., “accuracy”) can be specified for training, validating, and testing DNN 400.

DNN 400 can then be trained by passing the portion of the training dataset (e.g., 70% of the training dataset) designated for training and specifying a number of epochs. An epoch (one pass of the entire training dataset) is completed once all the observations of the training data are passed through DNN 400. DNN 400 can be validated once DNN 400 completes the specified number of epochs. For example, DNN 400 can process the training dataset and the loss/error value can be calculated and used to assess the performance of DNN 400. The loss value indicates how well DNN 400 is trained. Note that a higher loss value means DNN 400 is not sufficiently trained. In this case, hyperparameter tuning may be performed. Hyperparameter tuning may include, for example, changing the loss function, changing optimizer algorithm, and/or changing the neural network architecture by adding more hidden layers. Additionally or alternatively, the number of epochs can be also increased to further train DNN 400. In any case, once the loss is reduced to a very small number (ideally close to 0), DNN 400 is sufficiently trained for prediction. Prediction of the model (e.g., DNN 400) can be achieved by passing the independent variable of test data (i.e., for comparing train vs. test) or the real values that need to be predicted to predict whether a parts configuration specified for a product will result in issues.

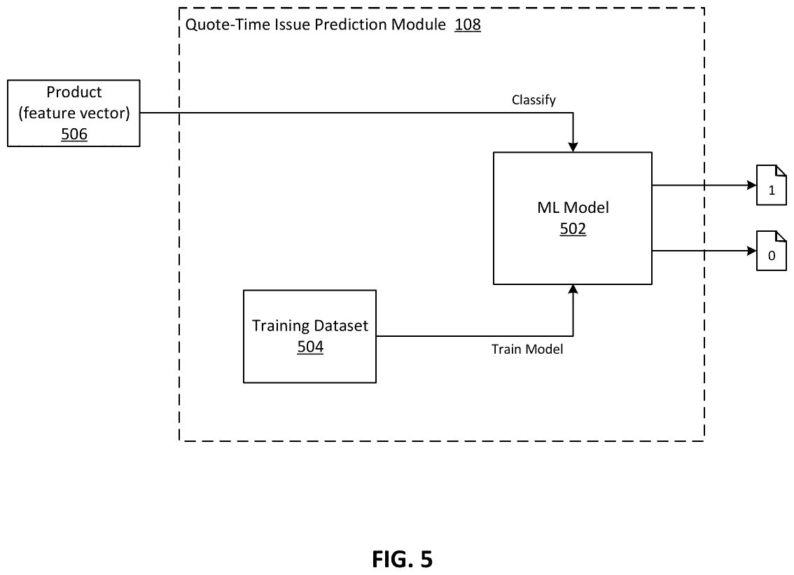

Once sufficiently trained, as illustrated in FIG. 5 in which like elements of FIG. 1 are shown using like reference designators, quote-time issue prediction module 108 can be used to predict whether a parts configuration specified for a product will result in issues. In other words, quote-time issue prediction module 108 can be used to determine whether a product having a specified parts configuration will result in issues. As shown in FIG. 5, quote-time issue prediction module 108 includes a machine learning (ML) model 502. As described previously, according to one embodiment, ML model 502 can be a DNN (e.g., DNN 400 of FIG. 4). ML model 502 can be trained and tested using machine learning techniques with a training dataset 504. Training data set 504 can be provided by product data repository 106. As described previously, the training dataset for ML model 502 may be generated from the historical product data. The trained ML model 502 can then be used to predict whether a parts configuration specified for a product 506 will result in issues (“1”) or will not result in issues (“0”). For example, a feature vector that represents the features from product 506, such as customer, product, configuration part, supplier, customer location, etc., may be input, passed, or otherwise provided to the trained ML model 502. In some embodiments, the input feature vector may include the same features used in training the trained ML model 502.

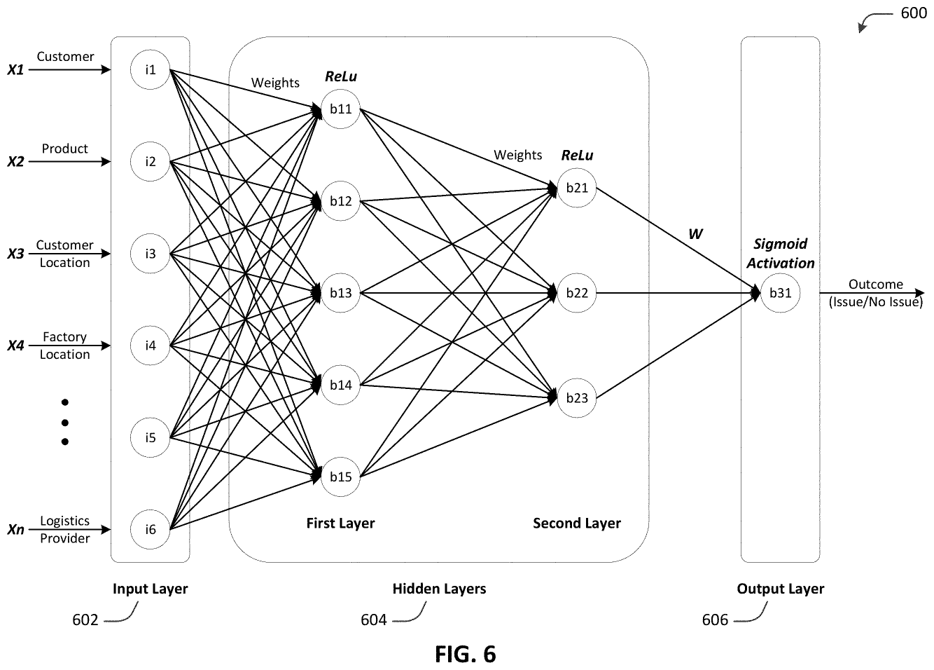

Referring again to FIG. 1, manufacture-time issue prediction module 110 can predict whether producing a product having a specified parts configuration in accordance with a selected manufacturing details will result in issues. To this end, in some embodiments, manufacture-time issue prediction module 110 includes a learning model (e.g., a DNN 600 as shown in FIG. 6) that is trained using machine learning techniques with a training dataset generated using historical product and manufacturing data. Similar to DNN 400 described above, DNN 600 of manufacture-time issue prediction module 110 may be a binary classification model (e.g., a binary classifier). In such embodiments, the training dataset may be provided by product data repository 106.

As can be seen in FIG. 6, DNN 600 includes an input layer 602, multiple hidden layers 604 (e.g., two hidden layers), and an output layer 606. Input layer 602 may be comprised of a number of neurons to match (i.e., equal to) the number of input variables (independent variables). Taking as an example the independent variables illustrated in data structure 300 (FIG. 3), input layer 602 may include 7 neurons to match the 7 independent variables (e.g., customer 302, product 304, configuration part 306, supplier 308, customer location 310, manufacturing/factory location 312, and logistics provider 314), where each neuron in input layer 602 receives a respective independent variable. Each succeeding layer (e.g., a first layer and a second layer) in hidden layers 604 will further comprise an arbitrary number of neurons, which may depend on the number of neurons included in input layer 602. As a binary classification model, output layer 606 includes a single neuron. As DNN 600 is a binary classification model, in embodiments, DNN 600 can be created using substantially the same or similar architecture, function(s) and/or algorithm(s), training, testing, and validation techniques, and implementation as described above with respect to DNN 400 of FIG. 4.

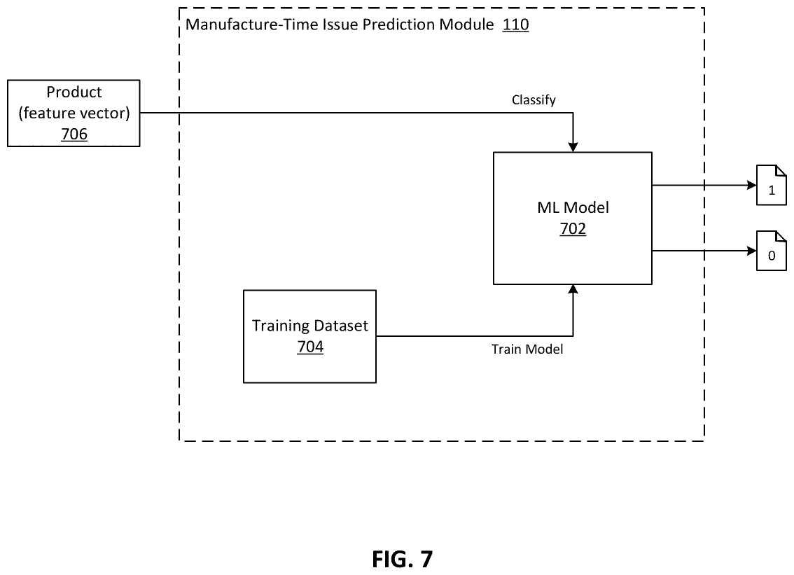

Once sufficiently trained, as illustrated in FIG. 7 in which like elements of FIG. 1 are shown using like reference designators, manufacture-time issue prediction module 110 can be used to predict whether producing a product having a specified parts configuration in accordance with a selected manufacturing details will result in issues. In other words, manufacture-time issue prediction module 110 can be used to determine whether producing the product in accordance with the selected manufacturing details will result in issues. As shown in FIG. 7, manufacture-time issue prediction module 110 includes a machine learning (ML) model 702. As described previously, according to one embodiment, ML model 702 can be a DNN (e.g., DNN 600 of FIG. 6). ML model 702 can be trained and tested using machine learning techniques with a training dataset 704. Training data set 704 can be provided by product data repository 106. As described previously, the training dataset for ML model 702 may be generated from the historical product and manufacturing data. The trained ML model 702 can then be used to predict whether producing a 706 having a specified parts configuration in accordance with a selected manufacturing details will result in issues (“1”) or will not result in issues (“0”). For example, a feature vector that represents the features from product 706, such as customer, product, configuration part, supplier, customer location, manufacturing/factory location, logistics provider, etc., may be input, passed, or otherwise provided to the trained ML model 702. In some embodiments, the input feature vector may include the same features used in training the trained ML model 702.

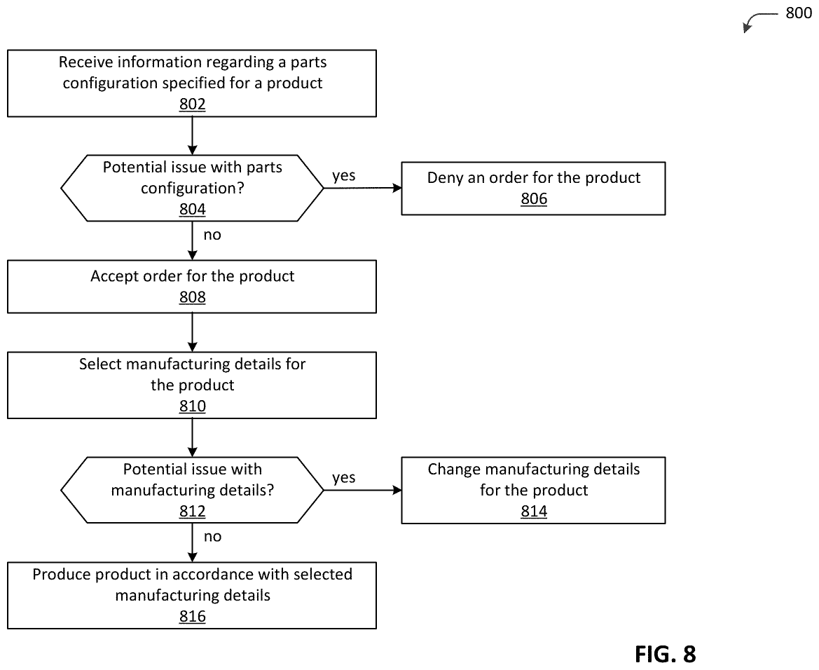

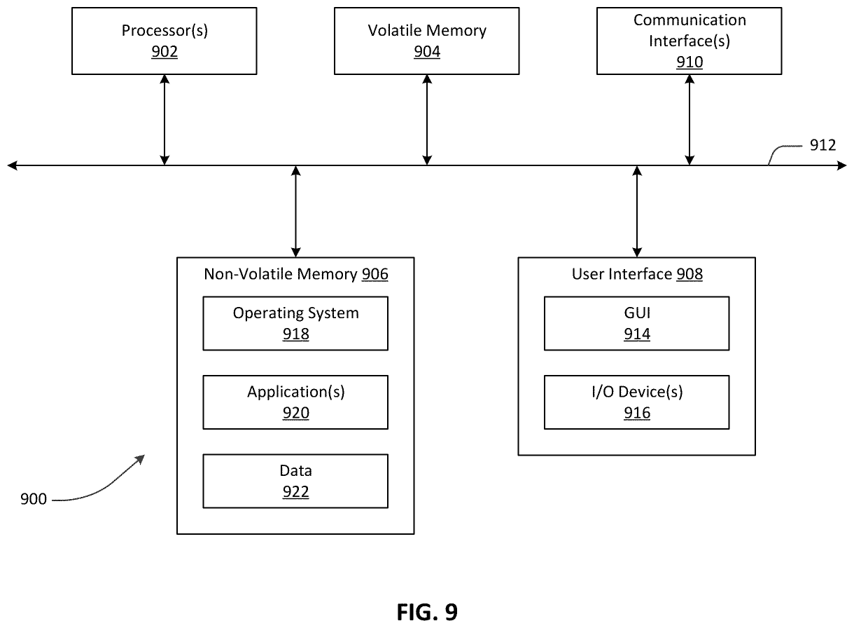

FIG. 8 is a flow diagram of an example process 800 for predicting product issues, in accordance with an embodiment of the present disclosure. Process 800 may be implemented or performed by any suitable hardware, or combination of hardware and software, including without limitation the system shown and described with respect to FIG. 1, the computing device shown and described with respect to FIG. 9, or a combination thereof. For example, in some embodiments, the operations, functions, or actions illustrated in process 800 may be performed, for example, in whole or in part by order management system 104, quote-time issue prediction module 108, and manufacture-time issue prediction module 110, or any combination of these including other components of product issue determination system 102 described with respect to FIG. 1.

With reference to process 800 of FIG. 8, and in an illustrative use case, at 802, order management system 104 can receive information regarding a parts configuration specified for a product. For example, the parts configuration for the product may be specified by a customer who is placing an order for the product or contemplating placing an order for the product.

At 804, order management system 104 can determine whether the parts configuration specified for the product will result in issues or will not result in issues. In some embodiments, order management system 104 can make this determination based on the output (i.e., prediction) of quote-time issue prediction module 108.

If it is determined that the parts configuration specified for the product will result in issues, then, at 806, order management system 104 can deny (not enter) an order for the product having the specified parts configuration. In one embodiment, order management system 104 can provide a notification of the potential issues with the specified parts configuration for the product.

Otherwise, if it is determined that the parts configuration specified for the product will not result in issues, then, at 808, order management system 104 can accept (enter) an order for the product having the specified parts configuration. In one embodiment, order management system 104 can provide a notification of the entered order for the product.

At 810, order management system 104 can select manufacturing details for the product. For example, an associate of the enterprise (e.g., a product manufacturing team member) of the enterprise may specify the manufacturing details for producing the product.

At 812, order management system 104 can determine whether producing the product having the specified parts configuration in accordance with the selected manufacturing details will result in issues or will not result in issues. In some embodiments, order management system 104 can make this determination based on the output (i.e., prediction) of manufacture-time issue prediction module 110.

If it is determined that producing the product having the specified parts configuration in accordance with the selected manufacturing details will result in issues, then, at 814, order management system 104 can change the manufacturing details for the product. For example, order management system 104 can provide a notification of the potential issues with producing the product in accordance with the selected manufacturing details, and the associate may change the manufacturing details for the product.

Otherwise, if it is determined that producing the product having the specified parts configuration in accordance with the selected manufacturing details will not result in issues, then, at 816, order management system 104 can proceed with producing the product in accordance with the selected manufacturing details. In one embodiment, order management system 104 can provide a notification that the product having the specified parts configuration will be produced in accordance with the selected manufacturing details.

FIG. 9 is a block diagram illustrating selective components of an example computing device 900 in which various aspects of the disclosure may be implemented, in accordance with an embodiment of the present disclosure. As shown, computing device 900 includes one or more processors 902, a volatile memory 904 (e.g., random access memory (RAM)), a non-volatile memory 906, a user interface (UI) 908, one or more communications interfaces 910, and a communications bus 912.

Non-volatile memory 906 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 908 may include a graphical user interface (GUI) 914 (e.g., a touchscreen, a display, etc.) and one or more input/output (I/O) devices 916 (e.g., a mouse, a keyboard, a microphone, one or more speakers, one or more cameras, one or more biometric scanners, one or more environmental sensors, and one or more accelerometers, etc.).

Non-volatile memory 906 stores an operating system 918, one or more applications 920, and data 922 such that, for example, computer instructions of operating system 918 and/or applications 920 are executed by processor(s) 902 out of volatile memory 904. In one example, computer instructions of operating system 918 and/or applications 920 are executed by processor(s) 902 out of volatile memory 904 to perform all or part of the processes described herein (e.g., processes illustrated and described in reference to FIGS. 1 through 8). In some embodiments, volatile memory 904 may include one or more types of RAM and/or a cache memory that may offer a faster response time than a main memory. Data may be entered using an input device of GUI 914 or received from I/O device(s) 916. Various elements of computing device 900 may communicate via communications bus 912.

The illustrated computing device 900 is shown merely as an illustrative client device or server and may be implemented by any computing or processing environment with any type of machine or set of machines that may have suitable hardware and/or software capable of operating as described herein.

Processor(s) 902 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 902 may be analog, digital or mixed signal. In some embodiments, processor 902 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 910 may include one or more interfaces to enable computing device 900 to access a computer network such as a Local Area Network (LAN), a Wide Area Network (WAN), a Personal Area Network (PAN), or the Internet through a variety of wired and/or wireless connections, including cellular connections.

In described embodiments, computing device 900 may execute an application on behalf of a user of a client device. For example, computing device 900 may execute one or more virtual machines managed by a hypervisor. Each virtual machine may provide an execution session within which applications execute on behalf of a user or a client device, such as a hosted desktop session. Computing device 900 may also execute a terminal services session to provide a hosted desktop environment. Computing device 900 may provide access to a remote computing environment including one or more applications, one or more desktop applications, and one or more desktop sessions in which one or more applications may execute.

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A computer implemented method to predict whether a parts configuration specified for a product will result in issues, the method comprising:
receiving, by an order management system, a parts configuration specified for a product;
generating, by the order management system, a first feature vector that represents one or more features from the product;
predicting, by a trained quote-time issue prediction module, whether the parts configuration specified for the product will or will not result in issues based on the first feature vector; and
responsive to a prediction that the parts configuration specified for the product will not result in issues, accepting an order for the product.

2. The method of claim 1, wherein the trained quote-time issue prediction module is trained using a training dataset generated from a corpus of historical product data.

3. The method of claim 1, further comprising:
responsive to a prediction that the parts configuration specified for the product will result in issues, denying an order for the product.

4. The method of claim 1, wherein the trained quote-time issue prediction module includes a dense neural network (DNN).

5. The method of claim 4, wherein the DNN of the trained quote-time issue prediction module functions as a binary classifier.

6. The method of claim 1, further comprising:
receiving, by the order management system, manufacturing details selected for the product;
generating, by the order management system, a second feature vector that represents one or more features from the product and the manufacturing details selected for the product; and
predicting, by a trained manufacture-time issue prediction module, whether producing the product in accordance with the selected manufacturing details will or will not result in issues based on the second feature vector.

7. The method of claim 6, wherein the trained manufacture-time issue prediction module is trained using a training dataset generated from a corpus of historical product and manufacturing data.

8. The method of claim 6, wherein the trained manufacture-time issue prediction module includes a dense neural network (DNN).

9. The method of claim 8, wherein the DNN of the trained manufacture-time issue prediction module functions as a binary classifier.

10. A system comprising:
one or more non-transitory machine-readable mediums configured to store instructions; and
one or more processors configured to execute the instructions stored on the one or more non-transitory machine-readable mediums, wherein execution of the instructions causes the one or more processors to:
receive a parts configuration specified for a product;
generate a first feature vector that represents one or more features from the product;
predict, using a trained quote-time issue prediction module, whether the parts configuration specified for the product will or will not result in issues based on the first feature vector; and
responsive to a prediction that the parts configuration specified for the product will not result in issues, accept an order for the product.

11. The system of claim 10, wherein the trained quote-time issue prediction module is trained using a training dataset generated from a corpus of historical product data.

12. The system of claim 10, wherein execution of the instructions further causes the one or more processors to:
responsive to a prediction that the parts configuration specified for the product will result in issues, deny an order for the product.

13. The system of claim 10, wherein the trained quote-time issue prediction module includes a dense neural network (DNN).

14. The system of claim 13, wherein the DNN of the trained quote-time issue prediction module functions as a binary classifier.

15. The system of claim 10, wherein execution of the instructions further causes the one or more processors to:
receive manufacturing details selected for the product;
generate a second feature vector that represents one or more features from the product and the manufacturing details selected for the product; and
predict, using a trained manufacture-time issue prediction module, whether producing the product in accordance with the selected manufacturing details will or will not result in issues based on the second feature vector.

16. The system of claim 15, wherein the trained manufacture-time issue prediction module is trained using a training dataset generated from a corpus of historical product and manufacturing data.

17. The system of claim 16, wherein the trained manufacture-time issue prediction module includes a dense neural network (DNN).

18. The system of claim 17, wherein the DNN of the trained manufacture-time issue prediction module functions as a binary classifier.

19. A non-transitory, computer-readable storage medium has encoded thereon instructions that, when executed by one or more processors, causes a process to be carried out, the process comprising:
receiving a parts configuration specified for a product that is being ordered;
generating a first feature vector that represents one or more features from the product;
predicting, using a trained quote-time issue prediction module, whether the parts configuration specified for the product will or will not result in issues based on the first feature vector, wherein the trained quote-time issue prediction module is trained using a training dataset generated from a corpus of historical product data; and
responsive to a prediction that the parts configuration specified for the product will not result in issues, accepting an order for the product.

20. The storage medium of claim 19, wherein the process further comprises:
receiving manufacturing details selected for the product;
generating a second feature vector that represents one or more features from the product and the manufacturing details selected for the product; and
predicting, using a trained manufacture-time issue prediction module, whether producing the product in accordance with the selected manufacturing details will or will not result in issues based on the second feature vector, wherein the trained manufacture-time issue prediction module is trained using a training dataset generated from a corpus of historical product and manufacturing data.
